(19) United States
(12) Patent Application Publication
(10) Pub. No.: US 2004/0062409 A1
(43) Pub. Date: Apr. 1, 2004

(54) Communication system

(76) Inventor: Jes Anker Batting, Hellerup (DK)

Correspondence Address: Dykema Gossett, Suite 300 West, 1300 I Street N W, Washington, DC, 20005-3306, US

(21) Appl. No.: 10/450,685

(22) PCT Filed: Dec. 19, 2001
(86) PCT No.: PCT/DK01/00842

(30) Foreign Application Priority Data
Dec. 19, 2000 (DK) PA 2000 01905

(51) Int. Cl. H04R 25/00

(52) U.S. Cl. 381/323; 381/312

(57) ABSTRACT

The invention relates to a communication system comprising a housing adapted for placement behind an ear, the housing comprising a battery compartment which is pivotally mounted on the housing, and which has a recess. The communication system further comprises an communication element, which has a protruding element adapted for engagement with the recess in the battery compartment in such a manner that the communication element may be pivoted together with the battery compartment. Preferably the communication element when the battery compartment is in a closed position may not be displaced in relation to the communication device housing.

### AREA OF THE INVENTION

The invention relates to the area of communication devices and more specifically to communication devices for placement over the ear of a user. Such devices comprises hearing aids and headsets and similar constructions which are intended for bringing improvement to the listening situation for both normal hearing persons and hearing impaired. The invention especially is related to such devices comprising a separate transmitter or receiver for communication with a further external device.

### BACKGROUND OF THE INVENTION

In connection with hearing aids it is well known to provide a so-called audio shoe in connection with the hearing aid housing, where this audio shoe itself comprises the communication electronics or where the communication electronics may be connected to the audio shoe.

These previously known solutions all presents several disadvantages, where these comprise risk of loss of communication electronics due poor engagement with the hearing aid or the audio shoe, and requirement of dismantling for change of battery.

One previously known construction is disclosed in CH 641619. This prior art document discloses two possible locations of an externally mounted receiver. One possible location is on the top of the housing. Although this location does not prevent the change of a battery, which is normally placed in the lower end of the housing, it is disadvantageous since the mass center of the hearing aid and the receiver is moved upwards and since in a hearing aid normally a very limited space is available in this area due to the presence of microphones and microphone inlets. Another possible location is at the bottom of the housing. This location is advantageous in respect of the location of the mass center, but is disadvantageous in respect of the possibility of battery change since the receiver will block the opening of the battery compartment.

On this background an objective of the present invention is to provide a communication system which brings improvement to the risk of loss and which will allow change of a battery without dismantling of the communication system. A further objective is to provide a communication electronics element for connection with a communication device, which brings improvement to the risk of loss and which will allow change of a battery without dismantling of the communication electronics.

### SUMMARY OF THE INVENTION

According to the invention the first objective is achieved by means of a communication device as described in claim 1.

By means of such device the battery compartment may still be opened for change of the battery without dismantling the receiver. This is advantageous, especially for hearing aid users having limited ability of handling the small mechanical parts. The presence of the receiver even can give the possibility of providing an improvement to the handling as the receiver may function as a handle for the opening of the battery compartment.

Advantageous embodiments are depicted in claims 2-5.

By the embodiment of claim 2, the communication element may not, when the battery compartment is in a closed position, be displaced in relation to the hearing device housing an increased security against loss is achieved. When the battery compartment is closed the receiver is blocked against release in two directions. This is a significant security against loss of the receiver without the use of tools and fastening elements. Furthermore the change of a battery is still possible without the need of removing the communication element from the hearing aid as it simply pivots together with the battery compartment.

By the embodiment of claim 3, where the communication element and the housing are adapted for mutually snap-locking an efficient locking of the communication element and the housing may be achieved.

By the embodiment of claim 4, where the communication element is inserted in the recess in a direction generally parallel to the pivoting axis of the battery compartment an easy mounting of the communication element is achieved and the security against loss is realized in an reliable manner.

By the embodiment of claim 5, where a power switch is incorporated in the battery compartment, and which is activated by pivoting the battery compartment and where the communication element still may not be displaced in relation to the hearing device housing in this position of the battery compartment, the security against loss is maintained in the situation where such apparatus is turned off.

By the embodiment of claim 6, where a safety lock is incorporated in the battery compartment, and which prevents the pivoting of the battery compartment to a position where the battery may be removed and where the communication element still may not be displaced in relation to the hearing device housing in this position of the battery compartment, the security against loss is maintained in the situation where such apparatus is subject to an attempt of opening. This furthermore provides for an increased child safety of the communication element in the assembled state, as the communication element often is a tiny element that may be swallowed by children.

According to the invention the second objective is achieved by means of the communication electronics element as defined in claim 7.

The same advantages as mentioned in connection with claim 1 counts for this element as well.

By the embodiment of claim 8, where the communication element when the battery compartment is in a closed position may not be displaced in relation to the hearing device housing an increased security against loss of the communication element is achieved.

The invention will be explained more detailed in the following description of a preferred embodiment, with reference to the drawings.

### BRIEF DESCRIPTION OF THE DRAWINGS

FIG. 1 is a view of a communication device with a pivotable battery compartment in a open position, where an communication element has been mounted on the battery compartment;

FIG. 2 is an enlarged partial view of a communication device and an communication element in a separated position;

FIG. 3 is an enlarged partial view of a communication device and an communication element in an assembled position corresponding to FIG. 1;

FIG. 4 is an enlarged partial view of a communication device and an communication element in an assembled position corresponding to FIG. 1 and with the battery compartment in a closed position;

FIG. 5 is a side view of a battery drawer;

FIG. 6 is an end view of a battery drawer

FIG. 7 is a side view of a communication element;

FIG. 8 is an end view of a communication element.

### DESCRIPTION OF A PREFERRED EMBODIMENT

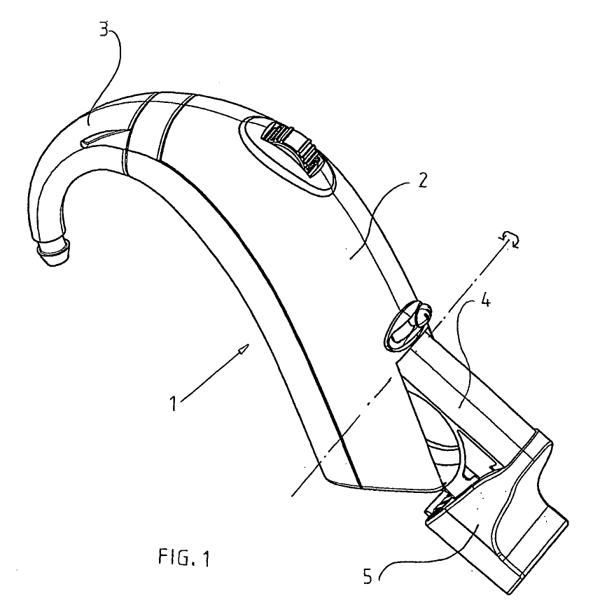

Referring to FIG. 1 a communication device in the form of a hearing aid 1 is shown. The hearing aid comprises a housing 2 and a so-called hook 3. In the housing several elements forming the sound processing part of the hearing aid are disposed. These parts, which are not shown, comprise a signal path having a microphone, a signal processor and a output transducer. In order to provide power to the operation of the signal path a battery is provided in a battery drawer 4. The battery drawer is hinged pivotally in the housing to allow opening for change of the battery. On the battery drawer a communication element 5 is provided. The actual communication element is a radio frequency receiver. A programming shoe for wired/wireless programming would be placed in a similar manner. It appears that the communication element is pivotally mounted together with the battery drawer to be pivoted about the same axis as the battery drawer.

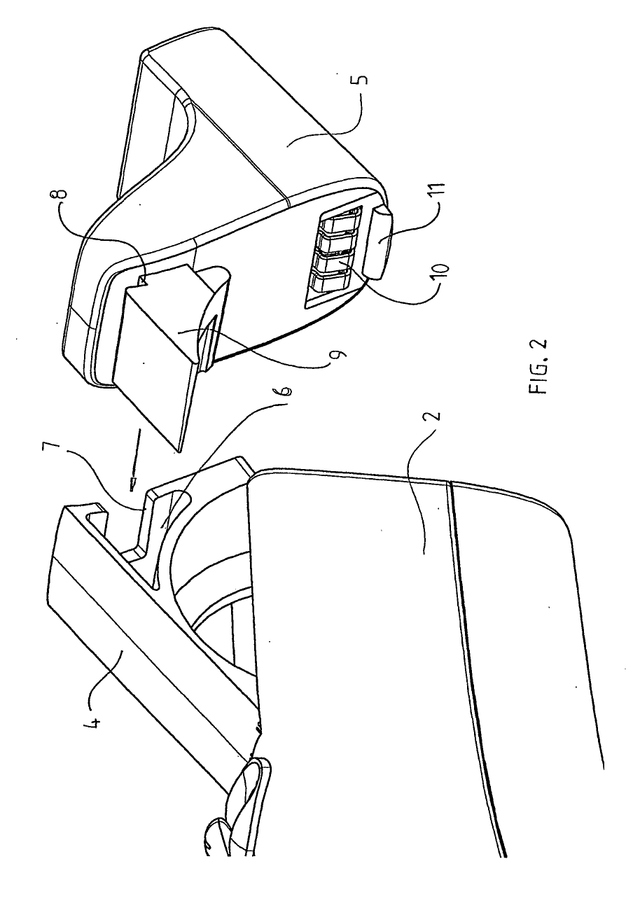

From FIG. 2 the communication element appears in a position separated from the hearing aid. It appears further that the communication element is assembled with the battery drawer by inserting the communication element into a recess 6 in the battery drawer. In one of the wall parts surrounding the recess an incision 7 or cutout provides space for a connection part 8 of the communication element, which connects the outward extending part of the communication element and an insertion part 9 being formed complementary to the recess. Contact elements 10 appears on the communication element, which are adapted for establishing electrical contact to the power supplying battery and for delivering an output signal to the hearing aid signal path to allow the hearing impaired to listen to the received radio frequency signal. Corresponding contact elements (not shown) are located on the housing. Furthermore a part of a locking mechanism 11 is visible on the communication element.

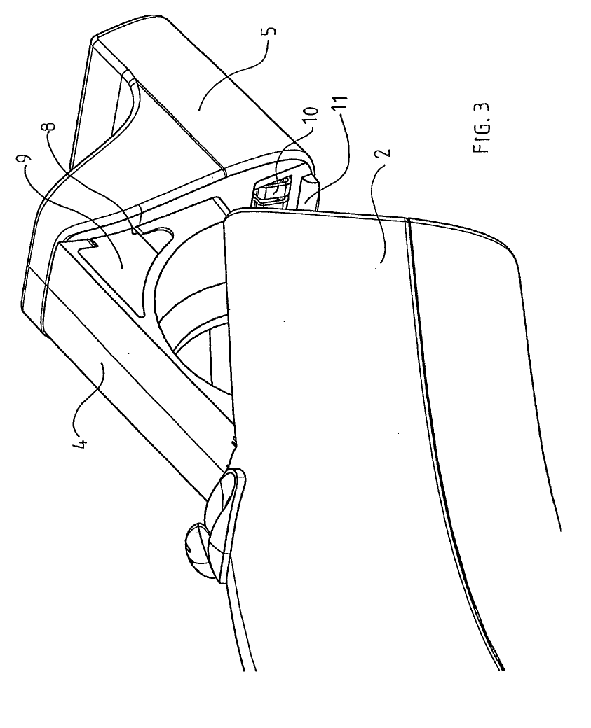

Referring to FIG. 3 the communication element appears in a position mounted on the battery drawer. This corresponds to the view shown in FIG. 1.

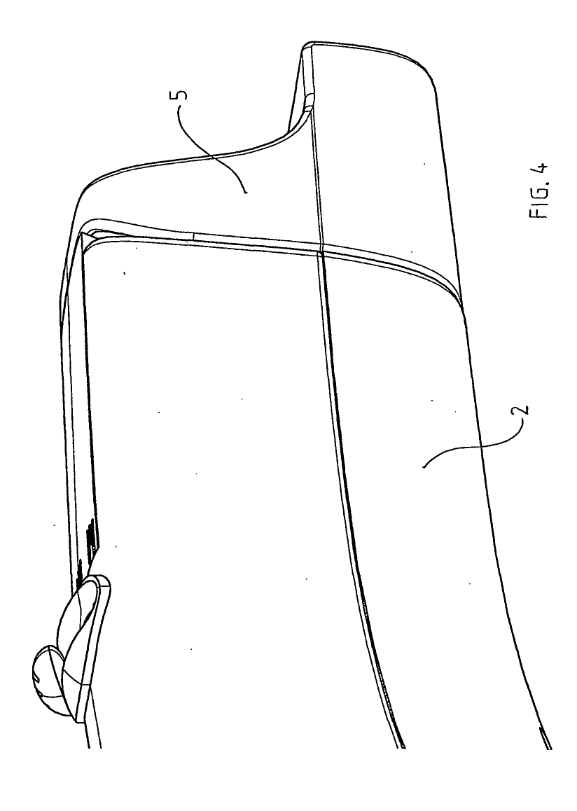

Referring to FIG. 4 the battery drawer together with the communication element has been pivoted to a closed position. It appears that the construction allows the hearing aid housing and the communication element to be flush with each other, hereby enhancing the esthetics of the construction and furthermore reducing the size of the assembled construction leading to less irritation when placing the device behind the ear of a user. It is obvious that when attempting to displace the communication element to the side in relation to the housing the movement will be blocked by the housing, hence providing an increased safety against loss.

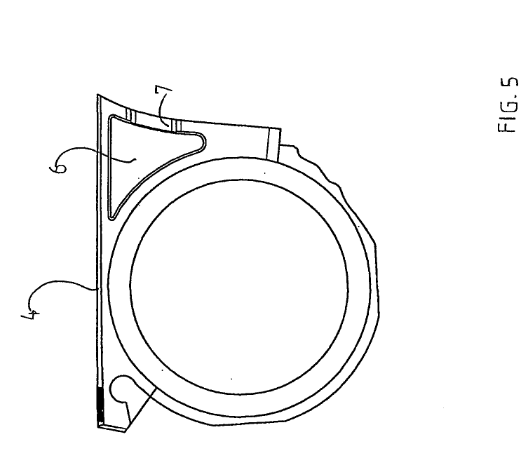

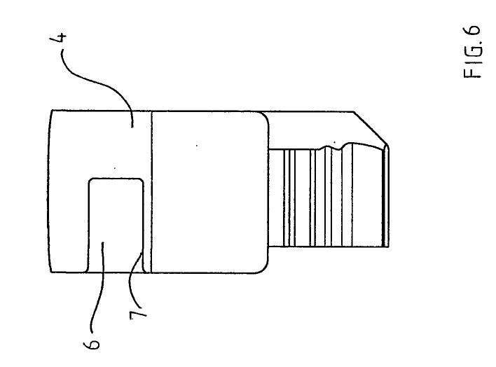

From FIG. 5 and FIG. 6 the battery drawer appears seen in a side view and an end view. The recess and the incision for accommodation of part of the communication element appear more detailed.

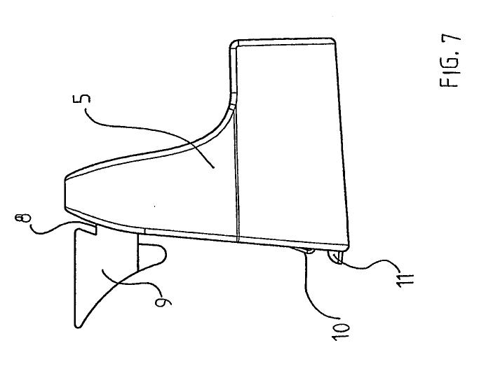

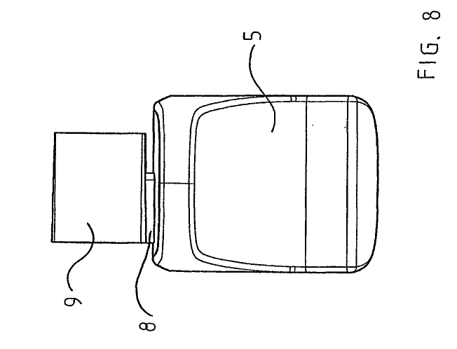

From FIG. 7 and FIG. 8 the communication element appears seen in a side view and an end view. The protruding part adapted for accommodation in the recess of the battery drawer appears with the connection part extending through the incision and the larger part having a cross section complementary to the cross section of the recess.

As an alternative the recess could be located in the communication element and the complimentary part could be located on the battery drawer, hereby simply inverting the location of the two mutually cooperating parts.

1. A communication system comprising a housing adapted for placement behind the ear, the housing comprising a battery compartment which is pivotally mounted on the housing, and which has a recess, the hearing device further comprising an communication element, which has a protruding element adapted for engagement with the recess in the battery compartment in such a manner that the communication element may be pivoted together with the battery compartment about the same pivoting axis.

2. A communication system according to claim 1, where that the communication element when the battery compartment is in a closed position may not be displaced in relation to the hearing device housing.

3. A communication system according to claim 1 or 2, where the communication element and the housing are adapted for mutually snap-locking.

4. A communication system according to claim 1, 2 or 3, where the communication element is inserted in the recess in a direction generally parallel to the pivoting axis of the battery compartment.

5. A communication system according to any of the claims 1-4, where a power switch is incorporated in the battery compartment, and which is activated by pivoting the battery compartment and where the communication element still may not be displaced in relation to the communication device housing in this position of the battery compartment.

6. A communication system according to any of the claims 1-5, where a safety lock is incorporated in the battery compartment, and which prevents the pivoting of the battery compartment to a position where the battery may be removed and where the communication element still may not be displaced in relation to the communication device housing in this position of the battery compartment.

7. An communication element for use in a communication system as defined in any of the claim 1-6, where the hearing system comprises a communication device having a housing adapted for placement behind an ear, the housing comprising a battery compartment which is pivotally mounted on the housing, and which has a recess, where the communication element has a protruding element adapted for engagement with the recess in the battery compartment in such a manner that the communication element may be pivoted together with the battery compartment about the same pivoting axis.

8. An communication element according to claim 7, where the communication element when the battery compartment is in a closed position may not be displaced in relation to the communication device housing
